(19) United States
(12) Patent Application Publication
(10) Pub. No.: US 2025/0118750 A1
(43) Pub. Date: Apr. 10, 2025

(54) NEGATIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Gyeonggi-do (KR)

(72) Inventors: Jong Heon SEOL, Gyeongsangnam-do (KR); Seong Ho JEON, Gyeongsangnam-do (KR); Tae Hyun HWANG, Gyeonggi-do (KR); Ho KIM, Gyeonggi-do (KR); Jung Hyun NAM, Gyeonggi-do (KR); Min Jae KIM, Gyeonggi-do (KR); Jung Keun YOO, Gyeonggi-do (KR); Ji Hee YOON, Gyeonggi-do (KR)

(73) Assignee: SAMSUNG SDI CO., LTD., Gyeonggi-do (KR)

(21) Appl. No.: 18/905,866

(22) Filed: Oct. 3, 2024

(30) Foreign Application Priority Data
Oct. 6, 2023 (KR) 10-2023-0133492

(51) Int. Cl. H01M 4/583; H01M 4/02; H01M 4/04; H01M 4/60; H01M 4/62

(52) U.S. Cl. CPC H01M 4/5835; H01M 4/0404; H01M 4/602; H01M 4/621; H01M 4/625; H01M 2004/027; H01M 2220/30

(57) ABSTRACT

A negative electrode for a rechargeable lithium battery and a rechargeable lithium battery including the same, the negative electrode including a current collector; and a negative electrode active material layer located on the current collector and including a negative electrode active material. The negative electrode active material includes a silicon-based composite, the silicon-based composite is a composite of a silicon-based active material, a phenoxy resin, and carbon nanotubes, and a weight ratio of the silicon-based active material and the carbon nanotubes ranges from about 1:0.0013 to about 1:0.01.

### CROSS-REFERENCE TO RELATED APPLICATION

The present application claims the benefit of priority to Korean Patent Application No. 10-2023-0133492, filed on Oct. 6, 2023 in the Korean Intellectual Property Office, the entire disclosure of which is incorporated herein by reference.

### BACKGROUND

### 1. Field of the Disclosure

The present disclosure relates to a negative electrode for a rechargeable lithium battery and a rechargeable lithium battery including the same.

### 2. Discussion of Related Art

In recent years, with the rapid spread of electronic devices that use batteries, such as mobile phones, laptop computers, and electric vehicles, the demand for secondary batteries which are small-sized, lightweight, and have relatively high capacity have rapidly increased. Due to being lightweight and having high energy density, rechargeable lithium batteries are gaining attention as a driving power source of portable devices. Accordingly, research and development for improving performance of rechargeable lithium batteries is actively underway.

A rechargeable lithium battery is a battery including a positive electrode and a negative electrode including an active material which allows for intercalation and deintercalation of lithium ions and an electrolyte, and produces electrical energy through an oxidation-reduction reaction taking place when the lithium ions are intercalated and deintercalated to and from the positive electrode and the negative electrode.

Transition metal compounds such as lithium cobalt oxide, lithium nickel oxide, and lithium manganese oxide are mainly used as positive electrode active materials of rechargeable lithium batteries. As negative electrode active materials, crystalline carbon materials such as natural graphite or artificial graphite, or amorphous carbon materials may be used, or silicon-based active materials may be used.

Recently, in order to improve the energy density of rechargeable lithium batteries, a negative electrode active material layer has been formed thick, and in particular, attempts have been made to form a negative electrode active material layer in two layers using a silicon-based active material. However, in this case, there are problems such as collapse of a negative electrode structure due to volume expansion and contraction of the silicon-based active material during charging and discharging.

### SUMMARY OF THE DISCLOSURE

One example embodiment provides a negative electrode for a rechargeable lithium battery, which improves the electrical conductivity of a negative electrode active material, reinforces the durability of the negative electrode, increases the cycle life of the battery, and increases capacity during charging and discharging.

Another example embodiment provides a rechargeable lithium battery including the negative electrode for a rechargeable lithium battery.

A negative electrode for a rechargeable lithium battery according to one example embodiment includes: a current collector; and a negative electrode active material layer located on the current collector and including a negative electrode active material, wherein the negative electrode active material includes a silicon-based composite, the silicon-based composite is a composite of a silicon-based active material, a phenoxy resin, and carbon nanotubes, and a weight ratio of the silicon-based active material and the carbon nanotubes (silicon-based active material: carbon nanotubes) ranges from 1:0.0013 to 1:0.01.

A rechargeable lithium battery according to another example embodiment includes: the negative electrode for a rechargeable lithium battery; a positive electrode; and an electrolyte.

### BRIEF DESCRIPTION OF THE DRAWINGS

FIGS. 1A and 1B show SEM images of a silicon-based active material of Comparative Example 1 (FIG. 1A) and a silicon-based composite of Example 1 (FIG. 1B)

FIG. 2 is a conceptual diagram of a silicon-based composite according to one example embodiment.

FIGS. 3 to 6 schematically show a rechargeable lithium battery according to one example embodiment.

FIG. 7 shows results of evaluating the cycle life of rechargeable lithium batteries of Examples and Comparative Examples.

In FIG. 7, the X-axis represents the number of cycles (units: times), and the Y-axis represents the discharge capacity (units: m Ah/g).

### DETAILED DESCRIPTION OF EXEMPLARY EMBODIMENTS

Hereinafter, example embodiments will be described in detail to be easily carried out by those of ordinary skill in the art. However, the present disclosure may be implemented in various different forms and is not limited to the example embodiments described herein.

Terms used herein are only used to describe exemplary embodiments and are not intended to limit the present disclosure. A singular expression includes a plural expression unless the context clearly indicates otherwise.

Here, “a combination thereof” means a mixture, stack, composite, copolymer, alloy, blend, and reaction product of constituents.

Here, terms such as “including,” “being equipped with,” or “having” should be understood as designating the presence of an implemented feature, number, step, component, or a combination thereof and should not be understood as precluding the possibility of the presence or addition of one or more other features, numbers, steps, components, or combinations thereof.

In the drawings, thicknesses are exaggerated to clearly express various layers and regions, and like parts are denoted by the same reference numerals throughout the specification. When a part such as a layer, a membrane, a region or a plate is described as being “above” or “on” another part, this not only includes a case in which the part is “directly on” the other part, but also includes a case in which still another part is present therebetween. Conversely, when a certain part is described as being “directly on” another part, this means that still another part is not present therebetween.

Also, here, “layer” not only includes a shape formed on the entire surface but also includes a shape formed on a partial surface when observed in a plan view.

The term “or” should not be interpreted as having an exclusive meaning, and for example, “A or B” is interpreted as including A, B, (A+B), and the like.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Negative Electrode for Rechargeable Lithium Battery

A negative electrode for a rechargeable lithium battery according to one example embodiment includes a current collector; and a negative electrode active material layer located on the current collector and including a negative electrode active material, wherein the negative electrode active material includes a silicon-based composite.

The silicon-based composite is or includes a composite of a silicon-based active material, a phenoxy resin, and carbon nanotubes. Here, “composite” means that the silicon-based active material, the phenoxy resin, and the carbon nanotubes are integrated and thus are not separated into individual components during the process of preparing the silicon-based composite, the process of preparing the negative electrode active material layer, or operation of a rechargeable battery.

The carbon nanotubes may be fixed to and coated on a surface of the silicon-based active material. The negative electrode for a rechargeable lithium battery can further improve the electrical conductivity of the silicon-based active material because a distance between the silicon-based active material and the carbon nanotube is smaller compared to a negative electrode for a rechargeable lithium battery in which a carbon nanotube is separated from a silicon-based active material and included as a separate component (for example, a negative electrode including carbon nanotubes as a conductive additive).

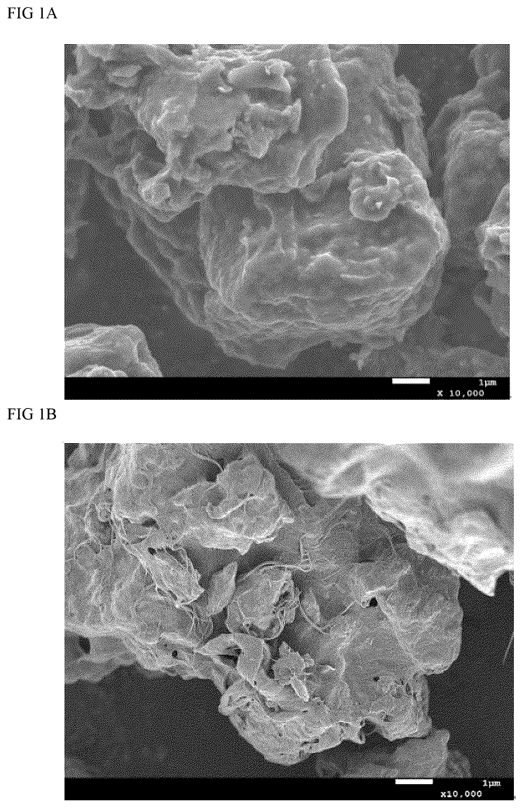

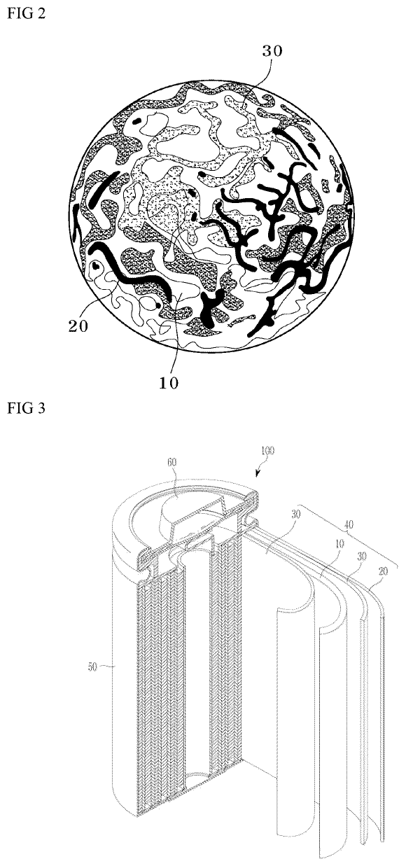

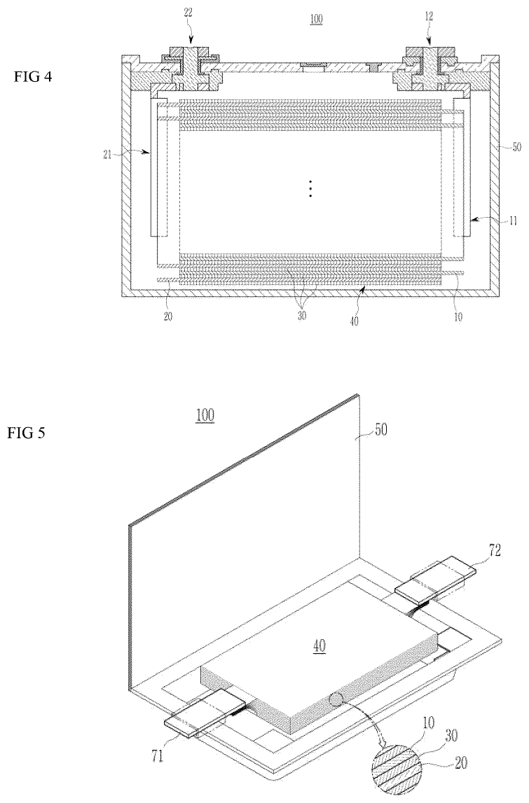

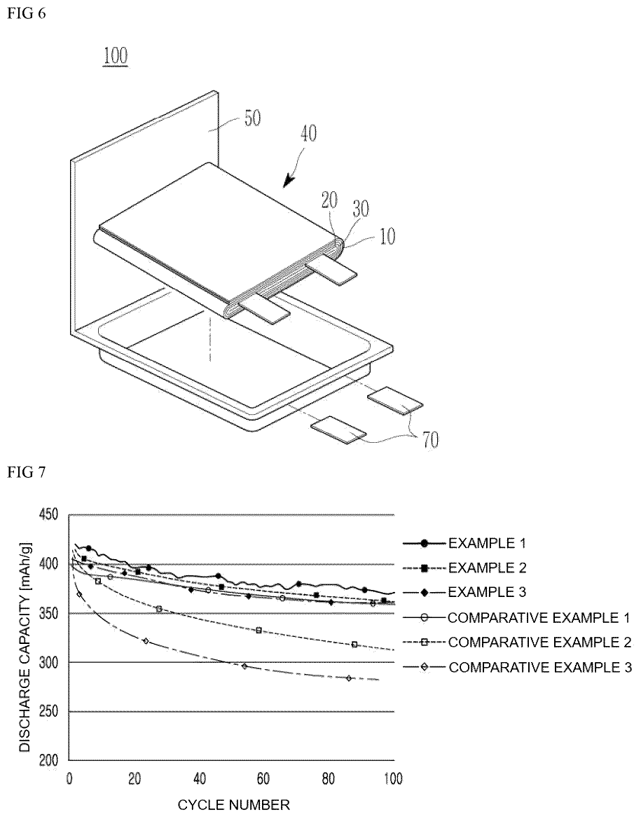

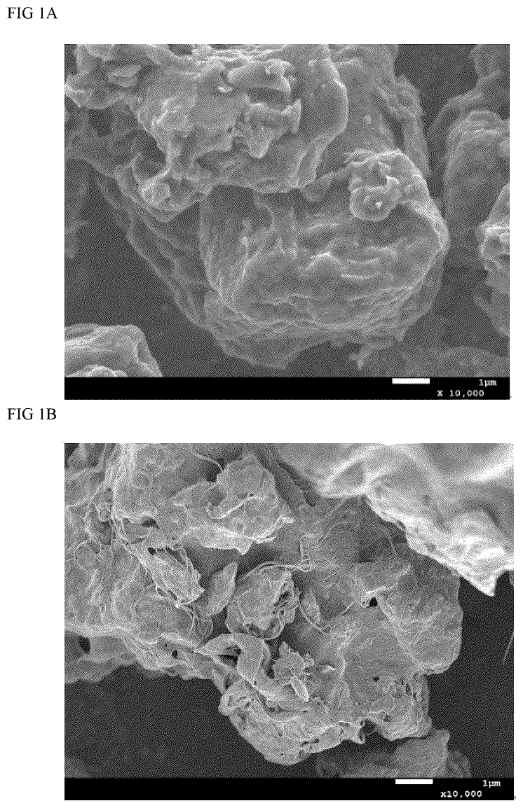

FIGS. 1A and 1B show a SEM image of each of a silicon-based active material and a silicon-based composite.

It can be seen that, in a silicon-based composite (FIG. 1B), thread-like carbon nanotubes are partially fixed to a silicon-based active material, compared to a silicon-based active material (FIG. 1A).

The carbon nanotube may be or include at least one of a single-wall carbon nanotube, a multi-wall carbon nanotube, or a combination thereof, and for example, may be a single-wall carbon nanotube. Since the single-wall carbon nanotube is more flexible and has a longer length than the multi-wall carbon nanotube and thus provides a high aspect ratio, contact between neighboring silicon-based composites in the negative electrode for a rechargeable lithium battery is further facilitated, thereby further improving electrical conductivity. Here, “aspect ratio” refers to a ratio of an average length of the carbon nanotube to a diameter thereof.

According to one example embodiment, the carbon nanotubes may have an aspect ratio of about 50 or more, for example, in the range of about 50 to about 10,000, about 500 to about 10,000, or about 500 to about 5,000. Within any of the above ranges of aspect ratio, it is readily possible to achieve the above-described effects.

According to one example embodiment, the carbon nanotubes may have a diameter ranging from about 0.5 nm to about 3 nm, for example, about 1 nm to about 3 nm, and may have an average length ranging from about 0.5 μm to about 20 μm, for example, about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm, and about 1 μm to about 10 μm. Within any of the above values or ranges of the diameter and the average length, neighboring silicon composites can more readily come in contact with each other due to the carbon nanotubes. Here, “average length” may refer to a complete linear length of the carbon nanotube or, instead of only referring to the complete linear length, may be an average value of a length that corresponds to the long axis of the carbon nanotube present in the negative electrode active material layer.

According to one example embodiment, a specific surface area by gas adsorption of the carbon nanotube in the silicon-based composite may range from about 600 m²/g to about 1,200 m²/g, for example about 600 m²/g, about 650 m²/g, about 700 m²/g, about 750 m²/g, about 800 m²/g, about 850 m²/g, about 900 m²/g, about 950 m²/g, about 1000 m²/g, about 1050 m²/g, about 1100 m²/g, about 1150 m²/g, and about 1200 m²/g. Within any of the above ranges, a problem of blockage of pores in the negative electrode due to an excessively large specific surface area of the carbon nanotube may not occur, and the carbon nanotube can be effectively fixed to a surface of the silicon-based active material.

The silicon-based active material may be or include a composite of silicon and carbon.

The composite of silicon and carbon may include a composite including silicon particles and a first carbon-based material. The first carbon-based material may be or include amorphous carbon or crystalline carbon. As an example, the composite may include a core in which silicon particles and a second carbon-based material are mixed; and a third carbon-based material surrounding the core. The second carbon-based material and the third carbon-based material may be the same or different, and may be or include amorphous carbon or crystalline carbon.

The amorphous carbon may be or include pitch carbon, soft carbon, hard carbon, mesophase pitch carbide, calcinated coke, carbon fibers, or a combination thereof. The crystalline carbon may be or include artificial graphite, natural graphite, or a combination thereof.

The silicon particles may have an average particle diameter ranging from about 10 nm to about 30 μm, and may be about 10 nm to about 1,000 nm, for example about 10 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, and about 1000 nm, according to one example embodiment, and about 20 nm to about 150 nm according to another example embodiment. When the average particle diameter of the silicon particles is within any of the above ranges, volume expansion of the silicon-based active material that occurs during charging and discharging can be reduced or suppressed, and interruption of a conductive path due to particles rupturing during charging and discharging can be reduced or prevented.

In the present specification, “particle diameter” may be an average particle diameter of particles. Here, “average particle diameter” may refer to a particle diameter D50 measured using a cumulative volume. Unless otherwise defined herein, the particle diameter D50 refers to a diameter of a particle with a cumulative volume of 50% by volume in a particle diameter distribution.

The average particle diameter D50 may be measured by methods well known to those skilled in the art. For example, the average particle diameter D50 may be measured using a particle size analyzer, a transmission electron microscope photograph, or a scanning electron microscope photograph. As another method, an average particle diameter D50 value may be obtained by measuring the particle diameter using a measuring device using dynamic light-scattering, performing data analysis to count the number of particles for each particle size range, and then calculating the particle diameter therefrom. The average particle diameter may be obtained from a diameter of a cross-section when the corresponding material has a spherical shape and obtained from the longest length of a cross-section when the corresponding material does not have a spherical shape.

When the composite of silicon and carbon includes silicon particles and a first carbon-based material, the content of the silicon particles may range from about 30 wt % to about 70 wt %, for example about 30 wt %, about 35 wt %, about 40 wt %, about 45 wt %, about 50 wt %, about 55 wt %, about 60 wt %, about 65 wt %, about 70 wt %, or about 40 wt % to about 50 wt % according to one example embodiment. The content of the first carbon-based material may range from about 70 wt % to about 30 wt %, for example about 30 wt %, about 35 wt %, about 40 wt %, about 45 wt %, about 50 wt %, about 55 wt %, about 60 wt %, about 65 wt %, and about 70 wt %, or about 60 to about 50 wt % according to one example embodiment. When the content of the silicon particles and the content of the first carbon-based material are within any of the above ranges, high capacity characteristics can be exhibited.

When the composite of silicon and carbon includes a core in which silicon particles and a second carbon-based material are mixed; and a third carbon-based material surrounding the core, the third carbon-based material may be present with a thickness ranging from about 5 nm to about 100 nm, for example about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm. Also, the third carbon-based material may be included in an amount ranging from about 1 wt % to about 50 wt %, for example about 1 wt %, about 5 wt %, about 10 wt %, about 15 wt %, about 20 wt %, about 25 wt %, about 30 wt %, about 35 wt %, about 40 wt %, about 45 wt %, about 50 wt %, with respect to 100 wt % of the silicon-based material, the silicon particles may be included in an amount ranging from about 30 wt % to about 70 wt %, for example about 30 wt %, about 35 wt %, about 40 wt %, about 45 wt %, about 50 wt %, about 55 wt %, about 60 wt %, about 65 wt %, about 70 wt %, with respect to 100 wt % of the silicon-based material, and the second carbon-based material may be included in an amount ranging from about 20 wt % to about 69 wt % for example about 20 wt %, about 25 wt %, about 30 wt %, about 35 wt %, about 40 wt %, about 45 wt %, about 50 wt %, about 55 wt %, about 60 wt %, about 65 wt %, about 69 wt %, with respect to 100 wt % of the silicon-based material. The content of the silicon particles, the content of the third carbon-based material, and the content of the second carbon-based material being within the above ranges may be advantageous because the discharge capacity may be desired or improved, and a capacity maintenance rate can be increased.

According to one example embodiment, the silicon-based active material may be included in an amount of about 95 wt % or more, for example, in the range of about 98 wt % to about 99.5 wt %, in the silicon-based composite. Within the above range, the function of the silicon-based active material may not be affected, and an effect of improving electrical conductivity can be provided.

According to one example embodiment, the silicon-based active material may be included in an amount ranging from about 1 wt % to about 10 wt % for example about 1 wt %, about 2 wt %, about 3 wt %, about 4 wt %, about 5 wt %, about 6 wt %, about 7 wt %, about 8 wt %, about 9 wt %, and about 10 wt %, in the negative electrode active material. Within the above range, the function of the silicon-based active material may not be affected, and an effect of improving electrical conductivity can be provided. For example, the silicon-based active material may be included in an amount ranging from about 1 wt % to about 8 wt % or about 1 wt % to about 5 wt % in the negative electrode active material.

According to one example embodiment, the silicon-based active material may be included in an amount ranging from about 1 wt % to about 10 wt %, for example about 1 wt %, about 2 wt %, about 3 wt %, about 4, wt % about 5 wt %, about 6 wt %, about 7 wt %, about 8 wt %, about 9 wt %, about 10 wt %, in the negative electrode active material layer. Within the above range, the function of the silicon-based active material may not be affected, and an effect of improving electrical conductivity can be provided. For example, the silicon-based active material may be included in an amount ranging from about 1 wt % to about 10 wt % or about 1 wt % to about 5 wt % in the negative electrode active material layer.

The phenoxy resin is one of the thermoplastic resins and may improve the output characteristics and the service life and performance of a rechargeable lithium battery by reinforcing the durability of the negative electrode for a rechargeable lithium battery.

The phenoxy resin is present on a surface of the silicon-based active material and has higher affinity for the silicon-based active material than other types of resins. Therefore, the phenoxy resin can reinforce the durability of the negative electrode by providing adhesive strength between the silicon-based active materials. Also, the phenoxy resin has high affinity for each of the silicon-based active material and the carbon nanotubes. Therefore, the phenoxy resin can improve electrical conductivity of the silicon-based active material by fixing the carbon nanotube to the surface of the silicon-based active material so that the carbon nanotube is integrated with the silicon-based active material without being separated from the silicon-based active material. The phenoxy resin may be advantageous in fixing and coating a material having a high aspect ratio, such as carbon nanotubes, on the surface of the silicon-based active material.

In particular, as will be described below, the silicon-based composite may be prepared by a method including a single step in which an organic dispersion containing carbon nanotubes and an organic solution containing the phenoxy resin are mixed and dispersed in the silicon-based active material. When the silicon-based composite is prepared using the method including the single step, the phenoxy resin may facilitate fixing of the carbon nanotubes to the surface of the silicon-based active material.

In an example, the phenoxy resin may facilitate improving the reliability of electrode manufacture by allowing the shape of the above-described composite to be maintained even in an aqueous slurry for a negative electrode for a rechargeable lithium battery.

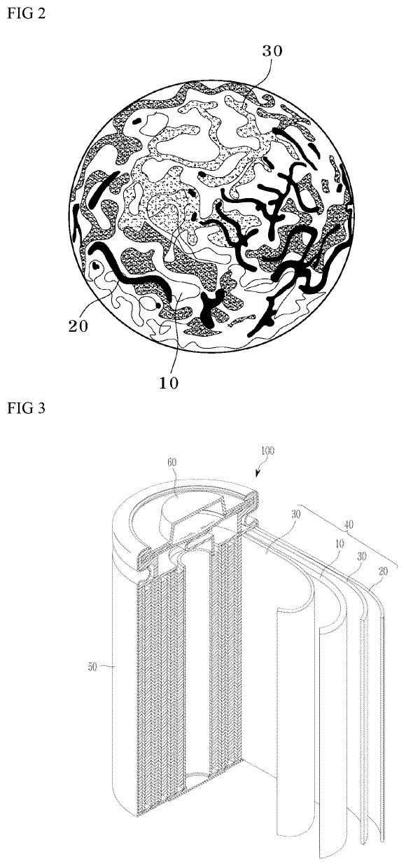

FIG. 2 is a conceptual diagram of a silicon-based composite, according to one example embodiment.

Referring to FIG. 2, the silicon-based composite may include a silicon-based active material 10, carbon nanotubes 20 fixed or attached to a surface of the silicon-based active material 10, and a phenoxy resin 30 fixed or attached to the surface of the silicon-based active material 10. The carbon nanotubes 20 may be fixed or attached to the surface of the silicon-based active material 10 via the phenoxy resin 30.

The phenoxy resin 30 may be present on one portion of the silicon-based active material 10.

According to one example embodiment, the phenoxy resin may be present only on one portion of the entire outer surface area of the silicon-based active material. In one example embodiment, the phenoxy resin may be present on about 50% or less, for example, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 2% 0, about 21%, about 22%, about 2% 3, about 2% 4, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47% %, about 48, about 49%, and about 50 wt %, about 1 to about 50% or about 1 to about 30%, of the outer surface area of the silicon-based active material. Within any of the above ranges or the above values, it may be readily possible to improve electrode durability without affecting negative electrode activity of the silicon-based active material.

According to one example embodiment, the carbon nanotube may be fixed to only one portion of the phenoxy resin in the silicon-based composite.

The phenoxy resin may have a weight average molecular weight of about 50,000 g/mol or more and less than about 500,000 g/mol. Within the above range, it may be readily possible to provide adhesive strength between the silicon-based active materials while reducing or suppressing the volume expansion of the silicon-based active material. For example, the weight average molecular weight may range from about 50,000 g/mol to about 400,000 g/mol or about 50,000 g/mol to about 300,000 g/mol. Here, “weight average molecular weight” may be obtained using gel permeation chromatography and calibrated with polystyrene.

A typical phenoxy resin known to those skilled in the art may be used as the phenoxy resin. For example, the phenoxy resin may be a thermoplastic resin having a repeating unit formed by a condensation reaction of bisphenol and epichlorohydrin. The bisphenol may be one or more of bisphenol A, bisphenol F, bisphenol Z, and bisphenol E.

In one example embodiment, the phenoxy resin may include a repeating unit of Chemical Formula 1 below.

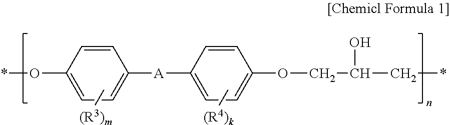

(In Chemical Formula 1 above,
* is a connecting portion of an element,
A is C(R¹)(R²) or S(O)₂, R¹ and R² are, each independently, hydrogen, a linear or branched C1 to C5 alkyl group, or a C6 to C10 aryl group, or R¹ and R² are connected to C and form a C5 to C10 ring,
R³ and R⁴ are, each independently, a linear or branched C1 to C5 alkyl group or C6 to C10 aryl group, m and k are, each independently, an integer from 0 to 4, and n is an integer of 2 or greater.)

According to one example embodiment, the phenoxy resin may be included in an amount ranging from about 0.01 wt % to about 10 wt %, for example about 0.01 wt %, about 0.05 wt %, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, in the silicon-based composite. Within the above range, there may be an effect of improving electrode durability without affecting the negative electrode activity of the silicon-based active material. For example, the phenoxy resin may be included in an amount ranging from 0.01 wt % to 5 wt %, 0.01 wt % to 3 wt %, or 0.01 wt % to 1 wt % in the silicon-based composite.

According to one example embodiment, the phenoxy resin may be included in an amount ranging from 0.001 to 5 wt %, for example about 0.001 wt %, about 0.005 wt %, about 0.01 wt %, about 0.05 wt %, about 0.1 wt %, about 1 wt %, about 2 wt %, about 3 wt %, about 4 wt %, about 5 wt %, in the negative electrode active material. Within the above range, the function of the silicon-based active material may not be affected, and an effect of improving electrical conductivity can be provided. For example, the phenoxy resin may be included in an amount ranging from about 0.01 wt % to 3 wt % or about 0.01 wt % to about 1 wt % in the negative electrode active material.

According to one example embodiment, the phenoxy resin may be included in an amount ranging from about 0.001 wt % to about 5 wt %, for example about 0.001 wt %, about 0.005 wt %, about 0.01 wt %, about 0.05 wt %, about 0.1 wt %, about 1 wt %, about 2 wt %, about 3 wt %, about 4 wt %, and about 5 wt %, in the negative electrode active material layer. Within the above range, the function of the silicon-based active material may not be affected, and an effect of improving electrical conductivity can be provided. For example, the phenoxy resin may be included in an amount ranging from about 0.01 wt % to about 3 wt % or about 0.01 wt % to about 1 wt % in the negative electrode active material layer.

In the silicon-based composite according to one example embodiment, a weight ratio of the silicon-based active material and the carbon nanotubes (silicon-based active material: carbon nanotubes) ranges from about 1:0.0013 to about 1:0.01. The weight ratio is set for the purpose of providing effects of significantly increasing the cycle life of the battery and capacity during charging and discharging when the carbon nanotubes are fixed and coated on the silicon-based active material by the phenoxy resin in the silicon-based composite. When the weight ratio is less than about 1:0.0013 or exceeds about 1:0.01, the effect of increasing the cycle life of the battery may not be advantageous. For example, the weight ratio may range from about 1:0.003 to about 1:0.009.

The carbon nanotubes may be included in an amount of about 0.01 wt % or more and less than about 0.04 wt % in the negative electrode active material layer. Within the above range, the effect of increasing the service life characteristics during charging and discharging of the battery may be desired or improved, and the effect of increasing the capacity may be greater compared to an electrode in which carbon nanotubes are not composited and are included as a separate component from the negative electrode active material.

In one example embodiment, the carbon nanotubes may be included in an amount ranging from about 0.01 to about 0.035 wt % or about 0.01 to about 0.03 wt % in the negative electrode active material layer.

In one example embodiment, in 100 parts by weight of the silicon-based active material and the carbon nanotubes, a weight ratio of the silicon-based active material and the carbon nanotubes (silicon-based active material: carbon nanotubes) may range from about 99.9:0.1 to about 97:3, for example, about 99.7:0.3 to about 98.5:1.5 or about 99.7:0.3 to about 98.98:1.02. Within any of the above ranges, the effects of the present disclosure may be readily achieved.

The silicon-based composite may be included in an amount ranging from 1 to about 10 wt %, for example, about 1 to 8 wt % or about 1 to 5 wt %, in the negative electrode active material. Within any of the above ranges, the above-described effects may be present.

The silicon-based composite may be prepared by the following method.

The phenoxy resin is mixed and dispersed in an organic dispersion containing carbon nanotubes in the silicon-based active material to prepare an organic dispersion containing the carbon nanotubes and the phenoxy resin.

The organic dispersion containing carbon nanotubes may be prepared by mixing and dispersing the carbon nanotubes in an organic solvent. The organic solvent may not be particularly limited as long as it does not dissolve the carbon nanotubes. Examples of the organic solvent may include N-methylpyrrolidone (NMP) or the like.

The carbon nanotubes may be included at a concentration ranging from about 0.1 to about 5 wt %, for example, about 0.5 to about 3 wt %, in the organic dispersion. Within any of the above ranges, it may be readily possible to prepare the silicon-based composite.

The phenoxy resin may be included at a concentration ranging from about 0.1 to about 5 wt %, for example, about 0.5 to about 3 wt %, in the organic dispersion. Within any of the above ranges, it may be readily possible to prepare the silicon-based composite.

The composite of silicon and carbon is mixed in the organic dispersion containing the carbon nanotubes and the phenoxy resin and dispersed at a temperature ranging from about 100 to about 150° C., and the solvent is subsequently dried to prepare the silicon-based composite in a powder form.

The negative electrode active material may further include a carbon-based active material in addition to the silicon-based composite.

As the carbon-based active material, crystalline carbon, amorphous carbon, or a combination thereof may be used. Examples of the crystalline carbon may include graphite such as natural graphite or artificial graphite that is irregular-shaped, plate-shaped, flake-shaped, spherical, or fibrous, and examples of the amorphous carbon may include at least one of soft carbon, hard carbon, mesophase pitch carbide, and calcinated coke.

When the negative electrode active material is a mixture of a carbon-based active material and a silicon-based active material, in 100 parts by weight of the mixture, a weight ratio of the carbon-based active material and the silicon-based active material (carbon-based active material: silicon-based active material) may range from about 50:50 to about 98:2, for example, about 60:40 to about 98:2. Within any of the above ranges, conductivity can be further improved while more effectively reducing or suppressing the volume expansion of the negative electrode active material.

In the negative electrode active material layer, the content of the negative electrode active material may range from about 90 to about 99 wt % in 100 parts by weight. Here, the “content of the negative electrode active material” may be the content of the silicon-based composite or the content of the mixture of the silicon-based composite and the carbon-based active material.

The negative electrode active material layer may further include a binder and/or a conductive additive. For example, the negative electrode active material layer may include about 90 wt % to about 99 wt % of the negative electrode active material, about 0.5 wt % to about 5 wt % of the binder, and about 0 wt % to about 5 wt % of the conductive additive.

The binder may allow negative electrode active material particles to be sufficiently bonded to each other and allow the negative electrode active material to be sufficiently bonded to a current collector. As the binder, a nonaqueous binder, an aqueous binder, a dry binder, or a combination thereof may be used.

Examples of the nonaqueous binder may include at least one of polyvinyl chloride, carboxylated polyvinyl chloride, polyvinyl fluoride, an ethylene-propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acryl rubber, butyl rubber, fluorinated rubber, polyethylene oxide, polyvinyl pyrrolidone, polyepichlorohydrin, polyphosphazene, poly(meth)acrylonitrile, an ethylene-propylene-diene copolymer, polyvinylpyridine, chlorosulfonated polyethylene, latex, polyester resin, (meth)acryl resin, phenol resin, epoxy resin, polyvinyl alcohol, and a combination thereof.

When the aqueous binder is used as the negative electrode binder, a cellulose-based compound that can impart viscosity may be further included. As the cellulose-based compound, at least one of carboxymethyl cellulose, hydroxypropyl methyl cellulose, methyl cellulose, alkali metal salts thereof, or a mixture of one or more thereof may be used. At least one of Na, K, or Li may be used as the alkali metal.

The dry binder is a polymer material that can be formed into fibers and may be or include, for example, at least one of polytetrafluoroethylene, polyvinylidene fluoride, a polyvinylidene fluoride-hexafluoropropylene copolymer, polyethylene oxide, or a combination thereof.

The conductive additive is used to impart conductivity to the electrode, and any electrically conductive material that does not cause chemical changes may be used as the conductive additive in a battery. Examples of the conductive additive may include carbon-based materials such as at least one of natural graphite, artificial graphite, carbon black, acetylene black, ketjen black, carbon fibers, and carbon nanofibers; metal-based materials in the form of metal powder or metal fibers and including at least one of copper, nickel, aluminum, silver, and the like; conductive polymers such as polyphenylene derivatives; or a mixture thereof. In one example embodiment, the carbon nanotube content in the conductive additive may range from 0 to about 0.001 wt %, for example, may be equal to 0 wt %.

As the negative electrode current collector, at least one of copper foil, nickel foil, stainless steel foil, titanium foil, nickel foam, copper foam, a polymer substrate having a conductive metal coated thereon, or combinations thereof may be selected and used.

A method of manufacturing the negative electrode for a rechargeable lithium battery is as follows.

A negative electrode active material layer is formed on the current collector. The negative electrode active material layer may be formed by a typical method of mixing a negative electrode active material, a binder, and selectively, a conductive additive in a solvent to prepare a slurry-type negative electrode active material composition, applying the negative electrode active material composition on a current collector, and drying the negative electrode active material composition.

### Rechargeable Lithium Battery.

According to one example embodiment, the rechargeable lithium battery includes the negative electrode for a rechargeable lithium battery; a positive electrode; and an electrolyte.

### Positive Electrode

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can constitute a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The positive electrode active material may include a compound (lithiated intercalation compound) that is capable of intercalating and deintercalating lithium. For example, at least one of a composite oxide of lithium and a metal including at least one of cobalt, manganese, nickel, and combinations thereof may be used.

The composite oxide may be or include a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0≤α≤2); LiₐNi_{1-b-c}Mn_{b}X_{c}O₂₋ₐDₐ (0.90≤a≤1.8, 0≤b≤0.5, 0≤c≤0.5, and 0≤α≤2); LiₐNi_{b}Co_{c}L¹_{d}G_{c}O₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; Gis Al, Cr, Mn, Fe, Mg, La, Ce, Sr, V, or a combination thereof; and L¹ is Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The binder may be configured to attach the positive electrode active material particles to each other and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., that does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as a polyphenylene derivative; or a mixture thereof.

The current collector may include Al, but is not limited thereto.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R-CN (wherein R is a C2 to C20 linear, branched, or cyclic hydrocarbon group, a double bond, an aromatic ring, or an ether bond, and the like; amides such as dimethylformamide; dioxolanes such as 1,3-dioxolane, 1,4-dioxolane, and the like; sulfolanes, and the like.

The non-aqueous organic solvents may be used alone or in combination of two or more solvents.

In addition, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN (SO₃C₂F₅)₂, Li(FSO₂)₂N (lithium bis(fluorosulfonyl)imide, LiFSI), LiC₄F₉SO₃, LiN (CₓF₂ₓ₊₁SO₂) (CyF_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of or including a polymer polyolefin including at least one of polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

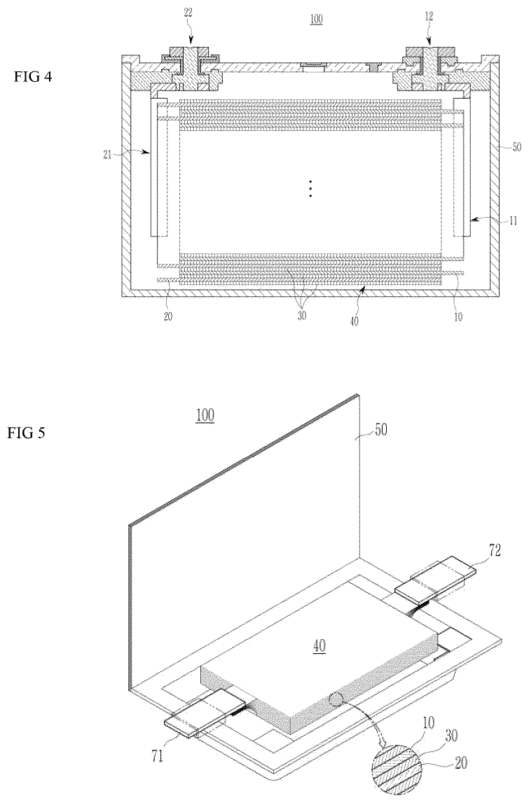

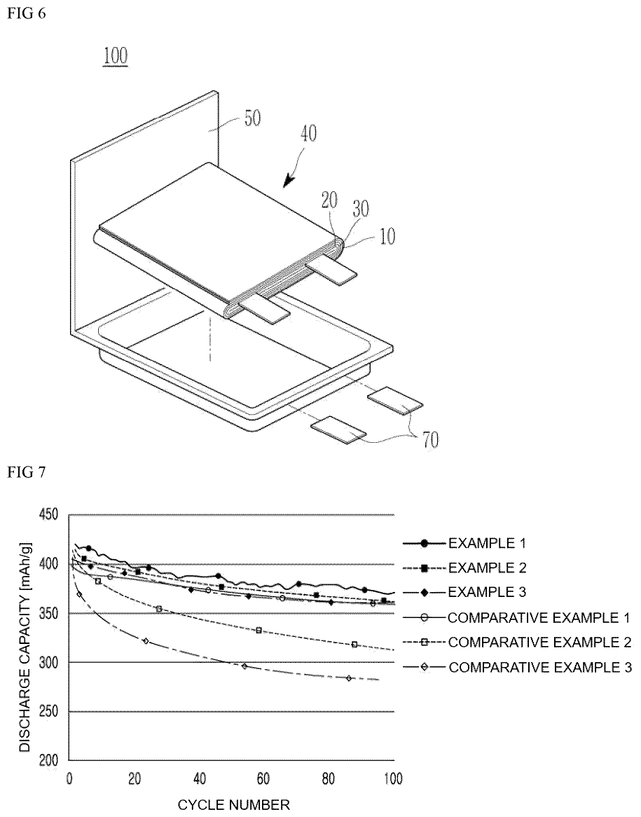

The rechargeable lithium battery may be classified into cylindrical, prismatic, pouch, or coin-type batteries, and the like depending on their shape. FIGS. 3 to 6 are schematic views illustrating a rechargeable lithium battery according to an example embodiment. FIG. 3 shows a cylindrical battery, FIG. 4 shows a prismatic battery, and FIGS. 5 and 6 show pouch-type batteries. Referring to FIGS. 3 to 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12, a negative lead tab 21, and a negative terminal 22. As shown in FIGS. 5 and 6, the rechargeable lithium battery 100 may include an electrode tab 70 in FIG. 6, which may be, for example, a positive electrode tab 71 and a negative electrode tab 72 in FIG. 5 and forming an electrical path for inducing the current formed in the electrode assembly 40 to the outside of the battery 100.

The rechargeable lithium battery according to an example embodiment may be used in, e.g., automobiles, mobile phones, and/or various types of electric devices, as non-limiting examples.

The following Examples and Comparative Examples are provided in order to highlight characteristics of one or more example embodiments, but it will be understood that the Examples and Comparative Examples are not to be construed as limiting the scope of the example embodiments, nor are the Comparative Examples to be construed as being outside the scope of the example embodiments. Further, it will be understood that the example embodiments are not limited to the particular details described in the Examples and Comparative Examples.

### EXAMPLE 1

Single-wall carbon nanotubes (SWCNTs) (average length: 1 μm to 10 μm, diameter: 1 nm to 3 nm, aspect ratio: 330 to 10,000) were dispersed at a concentration of 1 wt % in NMP, which is an organic solvent, to prepare an organic dispersion containing carbon nanotubes. TPB (Phenoxy PKHA, GABRIEL) was additionally added to the prepared SWCNT/NMP dispersion to prepare a liquid mixture. The organic dispersion containing the carbon nanotubes and phenoxy resin and a composite of silicon and carbon (SiC) were mixed and dispersed at 60 rpm at 120° C., and the organic solvent was subsequently removed, and drying was performed to prepare a silicon-based composite in a powder form.

The composite of silicon and carbon was a composite including a core including artificial graphite and silicon particles; and soft carbon coated on a surface of the core. A thickness of the soft carbon coating layer was 20 nm, and an average diameter D50 of the silicon particles was 100 nm.

The prepared silicon-based composite, natural graphite, and artificial graphite were mixed as a negative electrode active material, and carbon black (CB) as a conductive additive, styrene-butadiene rubber (SBR) as a binder, carboxymethyl cellulose (CMC) as a thickener, and a dispersant were mixed in a water solvent to prepare an aqueous slurry for a negative electrode active material layer.

In the mixing process, the content of each material in the aqueous slurry for a negative electrode active material layer was set to the content shown in Table 1 below based on solid content (the units are wt % in Table 1). The content of each material in the aqueous slurry for a negative electrode active material layer based on solid content was substantially the same as the content of each material in a negative electrode for a rechargeable lithium battery manufactured below.

The aqueous slurry for a negative electrode active material layer was applied on a copper foil current collector, and drying and rolling were performed to manufacture a negative electrode for a rechargeable lithium battery.

The negative electrode, a polyethylene/polypropylene separator, a lithium salt-containing positive electrode, and an electrolyte were used to manufacture a half-cell. The lithium salt-containing positive electrode included, based on solid content, a positive electrode active material layer including 95.8 wt % of lithium-nickel-aluminum salt, 2 wt % of multi-wall carbon nanotubes, 2 wt % of polyvinylidene fluoride, and 0.2 wt % of dispersant, and an Al current collector. As the electrolyte, a mixed solvent of ethylene carbonate, ethyl methyl carbonate, and dimethyl carbonate having a volume ratio of 20:10:70 in which 1.5M LiPF₆ was dissolved was used.

### EXAMPLES 2 and 3

A negative electrode for a rechargeable lithium battery and a rechargeable lithium battery were manufactured in the same manner as in Example 1, with a difference that in Example 1, the content of each material in the aqueous slurry for a negative electrode active material layer was changed as shown in Table 1 below.

### COMPARATIVE EXAMPLE 1

A composite of silicon and carbon, natural graphite, and artificial graphite were mixed as a negative electrode active material, and single-wall carbon nanotubes and carbon black as conductive additives, styrene-butadiene rubber as a binder, carboxymethyl cellulose as a thickener, and a dispersant were mixed in a water solvent to prepare an aqueous slurry for a negative electrode active material layer. The used composite of silicon and carbon, natural graphite, artificial graphite, single-wall carbon nanotubes, carbon black, styrene-butadiene rubber, carboxymethyl cellulose, and dispersant were the same as in Example 1.

In the mixing process, the content of each material in the aqueous slurry for a negative electrode active material layer was set to the content shown in Table 1 below based on solid content. The content of each material in the aqueous slurry for a negative electrode active material layer was substantially the same as the content of each material in a negative electrode for a rechargeable lithium battery manufactured below.

The aqueous slurry for a negative electrode active material layer was applied on a copper foil current collector, and drying and rolling were performed to manufacture a negative electrode for a rechargeable lithium battery.

Then, a positive electrode for a rechargeable lithium battery and a rechargeable lithium battery were manufactured in the same manner as in Example 1.

### COMPARATIVE EXAMPLES 2 and 3

A negative electrode for a rechargeable lithium battery and a rechargeable lithium battery were manufactured in the same manner as in Example 1, with a difference that in Example 1, the content of each material in the aqueous slurry for a negative electrode active material layer was changed as shown in Table 1 below.

### EXPERIMENTAL EXAMPLE 1: SEM Image Measurement of Silicon Composite

The silicon-based composite in the negative electrode manufactured in Example 1 was measured using a SEM image, and results thereof are shown in FIG. 1B. The composite of silicon and carbon in Comparative Example 1 was measured using a SEM image, and results thereof are shown in FIG. 1A. As shown in FIG. 1B, it can be seen that, in the silicon-based composite, thread-like carbon nanotubes are fixed to the silicon-based active material, as compared to the composite of silicon and carbon shown in FIG. 1A. In this way, it can be confirmed that the carbon nanotubes were not separated even during the process of preparing the silicon-based composite and the process of preparing the negative electrode active material layer.

### EXPERIMENTAL EXAMPLE 2: Cycle Life Characteristic Evaluation

A formation process was performed in which the rechargeable lithium batteries of Examples 1 to 3 and Comparative Examples 1 to 3 were charged at a constant current of 0.1 C to a cut-off voltage of 4.25 V at room temperature (25° C.), were charged at a constant voltage while maintaining 4.25 V until the current reached 0.05 C, and then were discharged at a constant current of 0.1 C until the voltage reached 2.8 V.

A standardization step was performed in which the batteries that underwent the formation process were charged at a constant current of 0.2 C until the voltage reached 4.25 V, were charged at a constant voltage while maintaining 4.25 V until the current reached 0.05 C, and then were discharged at a constant current of 0.2 C until the voltage reached 2.8 V. At this time, the charge capacity and discharge capacity were measured.

Each of the rechargeable lithium batteries of Examples 1 to 3 and Comparative Examples 1 to 3 that underwent the formation step and standardization step was charged at a constant current of 1 C until the voltage reached 4.25 V and were charged at a constant voltage while maintaining 4.25 V until the current reached 0.05 C. Then, a cycle of discharging at a constant current of 1 C until the voltage reached 2.8 V was repeated 100 times during discharging. A capacity ratio of 100th discharge capacity to 1st discharge capacity was obtained according to Equation 1 below, and results thereof are shown as a capacity maintenance rate in Table 2 below and shown in FIG. 7.

### Equation 1

Capacity maintenance rate (%)=(discharge capacity at 100th cycle/discharge capacity at 1^{st} cycle)×100

### Experimental Example 3: Elemental Analysis (Surface Element Analysis Method)

Elemental analysis was performed on silicon composites using Elementar's vario EL cube. 2.5 mg to 3 mg of silicon composite was sampled and burned in helium gas, and then a combustion product was subjected to gas chromatography for elemental analysis. In the combustion process, C, H, N, and S in the sample reacted with oxygen at high temperatures and were converted into CO₂, H₂O, N₂, and SO₂, respectively. The converted gases were separated in a column, and subsequently measured and quantified as a function of thermal conductivity using a detector. The results thereof are shown in Table 3 below.

Combustion temperature: 1,150° C./Reduction temperature: 850° C./Combustion time: 70 seconds

TABLE 1

| | Negative electrode active material | | | | | | | | | | |
|---|---|---|---|---|---|---|---|---|---|---|---|
| | Carbon-based | | | | | | Conductive | | | | |
| | Artificial | Natural | Silicon composite | | | | additive | | Binder | Thickener | |
| | graphite | graphite | SiC | SWCNT | TPB | Weight ratio | SWCNT | CB | SBR | CMC | Dispersant |
| Example 1 | 46.555 | 46.555 | 3.88 | 0.013 | 0.02 | 1:0.00335 | 0 | 0.45 | 1.7 | 0.8 | 0.027 |
| Example 2 | 46.557 | 46.557 | 3.88 | 0.012 | 0.02 | 1:0.00309 | 0 | 0.45 | 1.7 | 0.8 | 0.024 |
| Example 3 | 46.5275 | 46.5275 | 3.88 | 0.032 | 0.02 | 1:0.0082 | 0 | 0.45 | 1.7 | 0.8 | 0.063 |
| Comparative | 46.5325 | 46.5325 | 3.88 | 0 | 0 | — | 0.035 | 0.45 | 1.7 | 0.8 | 0.07 |
| Example 1 | | | | | | | | | | | |
| Comparative | 46.568 | 46.568 | 3.88 | 0.005 | 0.02 | 1:0.00128 | 0 | 0.45 | 1.7 | 0.8 | 0.009 |
| Example 2 | | | | | | | | | | | |
| Comparative | 46.5155 | 46.5155 | 3.88 | 0.04 | 0.02 | 1:0.010309 | 0 | 0.45 | 1.7 | 0.8 | 0.079 |
| Example 3 | | | | | | | | | | | |

*Weight ratio: weight ratio of composite of silicon and carbon (SiC) and carbon nanotubes in silicon composite (composite of silicon and carbon (SiC):carbon nanotubes)

TABLE 2

| | | | | Comparative | Comparative | Comparative |
|---|---|---|---|---|---|---|
| | Example 1 | Example 2 | Example 3 | Example 1 | Example 2 | Example 3 |
| 1^{st} cycle discharge | 405.17 | 402.38 | 400.44 | 397.64 | 411.77 | 407.09 |
| capacity (mAh/g) | | | | | | |
| 100^{th} cycle | 370.05 | 363.79 | 361.2 | 357.99 | 312.62 | 282.84 |
| discharge capacity | | | | | | |
| (mAh/g) | | | | | | |
| Capacity | 91.33 | 90.41 | 90.20 | 90.03 | 75.92 | 69.48 |
| maintenance rate | | | | | | |
| (%) | | | | | | |

As shown in Table 2 and FIG. 7, the negative electrode for a rechargeable lithium battery of each Example has a higher capacity maintenance rate than the negative electrodes of Comparative Examples 2 and 3.

TABLE 3

| | Nitrogen | Carbon | Hydrogen | | |
|---|---|---|---|---|---|
| | (%) | (%) | (%) | Sulfur (%) | Others (%) |
| Example 1 | 0.12 | 45.84 | 0.260 | 0.544 | 53.236 |
| Comparative | 0.05 | 44.39 | 0.299 | 0.415 | 54.846 |
| Example 1 | | | | | |
| Comparative | 0.55 | 46.27 | 0.600 | 0.306 | 52.274 |
| Example 3 | | | | | |

As in Table 3 above, the silicon-based active materials coated with a phenoxy resin according to Example 1 and Comparative Example 3 have a nitrogen content that is 0.1% or more and a carbon content that is 45% or more. On the other hand, the silicon-based active material that is not coated with a phenoxy resin according to Comparative Example 1 has a nitrogen content that is less than 0.1% and a carbon content that is less than 45%.

A negative electrode for a rechargeable lithium battery according to one example embodiment can provide the advantages of improving the electrical conductivity of a negative electrode active material, reinforcing the durability of the negative electrode, increasing the cycle life of the battery, and increasing capacity during charging and discharging.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A negative electrode for a rechargeable lithium battery, the negative electrode comprising:
a current collector; and
a negative electrode active material layer located on the current collector and including a negative electrode active material;
wherein the negative electrode active material includes a silicon-based composite, the silicon-based composite comprises a composite of a silicon-based active material, a phenoxy resin, and carbon nanotubes, and
a weight ratio of the silicon-based active material and the carbon nanotubes ranges from about 1:0.0013 to about 1:0.01.

2. The negative electrode of claim 1, wherein the silicon-based composite comprises a composite in which the carbon nanotubes and the phenoxy resin are attached to a surface of the silicon-based active material.

3. The negative electrode of claim 2, wherein the carbon nanotubes are attached to the surface of the silicon-based active material via the phenoxy resin.

4. The negative electrode of claim 2, wherein the phenoxy resin is present only on a portion of an outer surface area of the silicon-based active material.

5. The negative electrode of claim 1, wherein the phenoxy resin is included in an amount ranging from about 0.01 wt % to about 10 wt % in the silicon-based composite.

6. The negative electrode of claim 1, wherein the carbon nanotubes comprise single-wall carbon nanotubes.

7. The negative electrode of claim 1, wherein the carbon nanotubes have an aspect ratio of about 50 or more.

8. The negative electrode of claim 1, wherein the silicon-based active material comprises a composite of silicon and carbon.

9. The negative electrode of claim 1, wherein the silicon-based composite is included in an amount ranging from about 1 wt % to about 10 wt % in the negative electrode active material.

10. The negative electrode of claim 1, wherein the negative electrode active material further comprises a carbon-based active material.

11. The negative electrode of claim 1, wherein the negative electrode active material layer further comprises one or more of a conductive additive and a binder.

12. The negative electrode of claim 11, wherein the carbon nanotubes are included in an amount ranging from 0 wt % to about 0.001 wt % in the conductive additive.

13. A rechargeable lithium battery comprising:
the negative electrode of claim 1;
a positive electrode; and
an electrolyte.
